(19) United States
(12) Patent Application Publication
(10) Pub. No.: US 2022/0321612 A1
(43) Pub. Date: Oct. 6, 2022

(54) ENHANCED TEXT AND VOICE COMMUNICATIONS

(71) Applicant: WhatsApp LLC, Menlo Park, CA (US)

(72) Inventors: Arvind Swaminathan, San Jose, CA (US); Sammy El Ghazzal, Oberengstringen (CH)

(21) Appl. No.: 17/711,946

(22) Filed: Apr. 1, 2022

Related U.S. Application Data
(60) Provisional application No. 63/170,384, filed on Apr. 2, 2021.
(60) Provisional application No. 63/173,066, filed on Apr. 9, 2021.

(51) Int. Cl. H04L 65/1083; H04L 65/1069; H04L 65/403

(52) U.S. Cl. CPC H04L 65/1086; H04L 65/1069; H04L 65/403; H04L 65/65

(57) ABSTRACT

In one embodiment, a method includes initiating a real-time multimedia communication session with one or more other communication devices, detecting that an audio input level for an audio sample is lower than a threshold level based on sensor data from an audio sensor associated with the communication device, triggering a silence-detection timer, and entering, upon an expiration of the silence-detection timer, into a silence mode. Another method includes displaying one or more applications to a user, determining a context in which the user is interacting with the one or more applications and determining, based on the context, that the user intends to retrieve at least one message of the plurality of messages while the user is interacting with the one or more applications, generating a confidence score for each of the plurality of messages based on the user intent to retrieve the at least one message.

### PRIORITY

This application claims the benefit under 35 U.S.C. § 119(e) of U.S. Provisional Patent Application No. 63/170,384, filed 2 Apr. 2021, U.S. Provisional Patent Application No. 63/173,066, filed 9 Apr. 2021, which are incorporated herein by reference.

### TECHNICAL FIELD

This disclosure generally relates to digital communications, and in particular, related to text and voice communication enhancements.

### BRIEF DESCRIPTION OF THE DRAWINGS

FIG. 11 illustrates an example mode transitions based on audio input levels of audio samples from a microphone.

FIG. 12 illustrates an example adaptive retransmission based on cached data.

FIG. 13 illustrates an example adaptive retransmission based on information on the messages.

FIG. 14 illustrates an example method for adjusting audio bandwidth based on audio input levels of audio samples from a microphone.

FIG. 15 illustrates an example network environment associated with a social-networking system.

FIG. 21 and FIG. 22 illustrate a user device ecosystem.

FIG. 23 illustrates a user device and service platform environment useful in performing user context based message searching and mining.

FIG. 24 illustrates a flow diagram of a method for performing user context based message searching and mining.

FIG. 25 illustrates an example network environment associated with a virtual reality system.

FIG. 26 illustrates an example computer system.

### DESCRIPTION OF EXAMPLE EMBODIMENTS (ADJUSTING AUDIO BANDWIDTH)

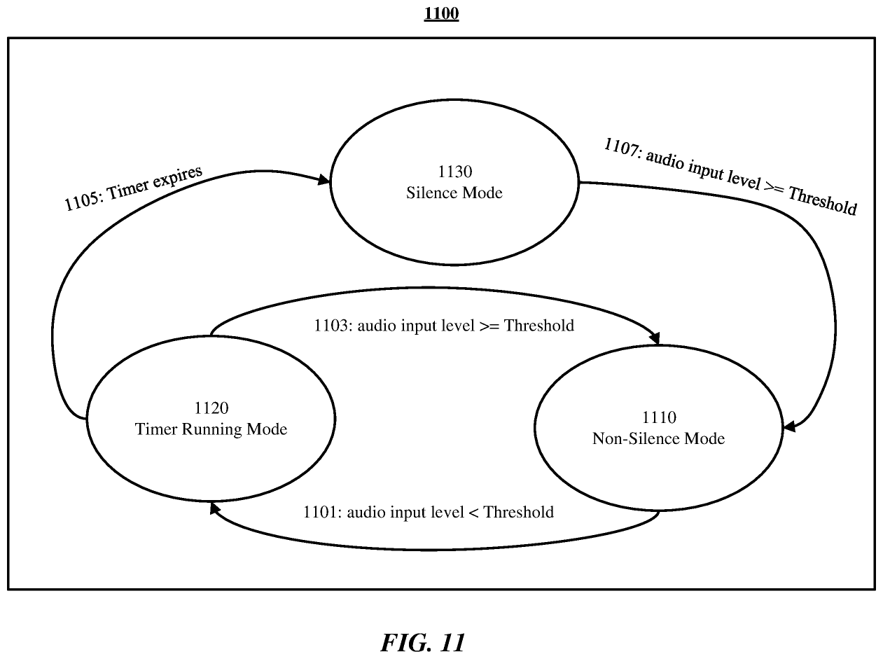

In particular embodiments, a communication device associated with a user may initiate a real-time multimedia communication session with one or more other communication devices. The real-time multimedia communication session may comprise an audio communication and a video communication. The communication device may detect that an audio input level for an audio sample is lower than a threshold level based on sensor data from an audio sensor associated with the communication device. The fact that the audio input level is lower than the threshold level may indicate that the user is silent. The communication device may trigger a silence-detection timer. The silence-detection timer may be cancelled when the audio input level for any of following audio samples is higher than the threshold level. The communication device may enter into a silence mode upon an expiration of the silence-detection timer. The communication device may reduce a bandwidth allocated for audio data when the communication device is in the silence mode. The communication device may leave the silence mode when the audio input levels for k consecutive audio samples are higher than the threshold level. FIG. 11 illustrates an example mode transitions based on audio input levels of audio samples from a microphone. As an example and not by way of limitation, illustrated in FIG. 11, a communication device 1100 may be in a non-silence mode 1110 while the communication device 1100 is in a real-time multimedia communication session with one or more other communication devices. In the non-silence mode 1110, the communication device 1100 may reserve a portion of communication bandwidth for potential audio retransmissions. When the communication device 1100 detects that audio input levels for a pre-determined number of consecutive audio samples taken from a microphone associated with the communication device 1100 are lower than a pre-determined threshold at step 1101, the communication device 1100 may move to a timer running mode 1120 and start a timer for a pre-determined amount of time. In the timer running mode 1120, the communication device 1100 may reserve a portion of communication bandwidth for potential audio retransmissions. When the communication device 1100 in the timer running mode 1120 detects that the audio input levels for the pre-determined number of consecutive audio samples are higher than the threshold at step 1103, the communication device 1100 may cancel the timer and return to the non-silence mode 1110. When the timer expires at step 1105, the communication device 1100 may enter into a silence mode 1130. In the silence mode 1130, the communication device 1100 may not reserve the bandwidth for audio data retransmissions. The communication device 1100 may allocate that bandwidth for video data. When the communication device 1100 in the silence mode 1130 detects that the audio input levels for the pre-determined number of consecutive audio samples are higher than the threshold at step 1107, the communication device 1100 may enter into the non-silence mode 1110. Although this disclosure describes adjusting an audio bandwidth based on audio input levels of audio samples in a particular manner, this disclosure contemplates adjusting an audio bandwidth based on audio input levels of audio samples in any suitable manner.

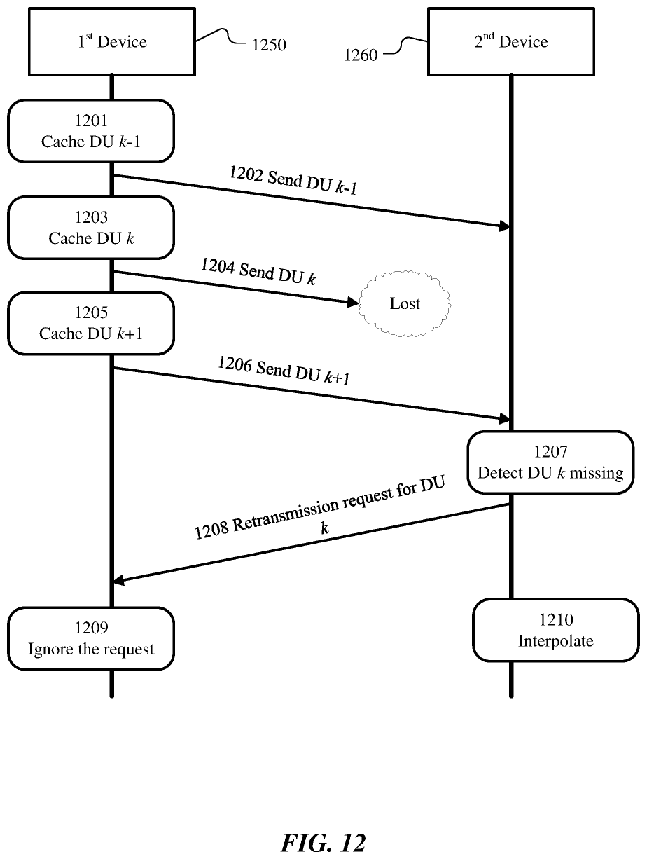

In particular embodiments, the communication device 1100 may prepare an audio data unit based on an audio sample while the communication device 1100 is in the silence mode 1130. The prepared audio data unit may be a Real-time Transport Protocol (RTP) data unit. The communication device 1100 may cache the prepared audio data unit. The cached audio data unit may have an additional field indicating that the audio data unit does not need to be re-transmitted. The communication device 1100 may send the prepared audio data unit to the one or more communication devices. The communication device 1100 may receive a request for a re-transmission of the prepared audio data unit from one of the one or more communication devices. In particular embodiments, the request may be an RTP Control Protocol (RTCP)-Negative Acknowledgement (NACK) message. The communication device 1100 may check the additional field of the cached audio data unit. The additional field of the cached audio data unit may indicate that the audio unit does not need to be re-transmitted because the communication device 1100 is in the silence mode 1130 when the communication device 1100 caches the audio data unit. The communication device 1100 may decide to ignore the request based on the additional field of the cached audio data unit. FIG. 12 illustrates an example adaptive retransmission based on cached data. As an example and not by way of limitation, illustrated in FIG. 12, a first communication device 1250 may be in a real-time multimedia communication session with a second communication device 1260. The real-time multimedia communication session may comprise an audio communication and a video communication. At step 1201, the first communication device 1250 may cache the k−1^{st} data unit for audio data. In particular embodiments, the cached k−1^{st} data unit for audio data may be an RTP data unit. The cached k−1^{st} data unit may have a field to indicate that the k−1^{st} data unit does not need to be re-transmitted because the first communication device 1250 is in the silence mode 1130. At step 1202, the first communication device 1250 may send the k−1^{st} data unit for audio data to the second communication device 1260. At step 1203, the first communication device 1250 may cache the k^{th} data unit for audio data. The cached k^{th} data unit may have a field to indicate that the k^{th} data unit does not need to be re-transmitted because the first communication device 1250 is in the silence mode 1130. At step 1204, the first communication device 1250 may send the k^{th} data unit for audio data to the second communication device 1260. The k^{th} data unit for audio data may have been lost, thus the second communication device 1260 may fail to receive the k^{th} data unit for audio data. At step 1205, the first communication device 1250 may cache the k+1^{st} data unit for audio data. At step 1206, the first communication device 1250 may send the k+1^{st} data unit for audio data to the second communication device 1260. At step 1207, the second communication device 1260 may detect that the k^{th} data unit for audio data is missing. At step 1208, the second communication device 1260 may send a retransmission request for the k^{th} data unit for audio data to the first communication device 1250. In particular embodiments, the retransmission request may be an RTCP-NACK message. At step 1209, the first communication device may check the cached k^{th} data unit for audio data. An additional field in the cached k^{th} data unit for audio data may indicate that the k^{th} data unit for audio data does not need to be re-transmitted. The first communication device 1250 may ignore the retransmission request from the second communication device 1260 based on the additional field in the cached k^{th} data unit for audio data. The second communication device 1260 may perform a normal interpolation-based packet concealment procedure at step 1210 because the second communication device 1260 has not received a retransmission for the k^{th} data unit for audio data. Although this disclosure describes determining a retransmission for a data unit generated while a communication device is in the silence mode based on cached data in a particular manner, this disclosure contemplates determining a retransmission for a data unit generated while a communication device is in the silence mode based on cached data in any suitable manner.

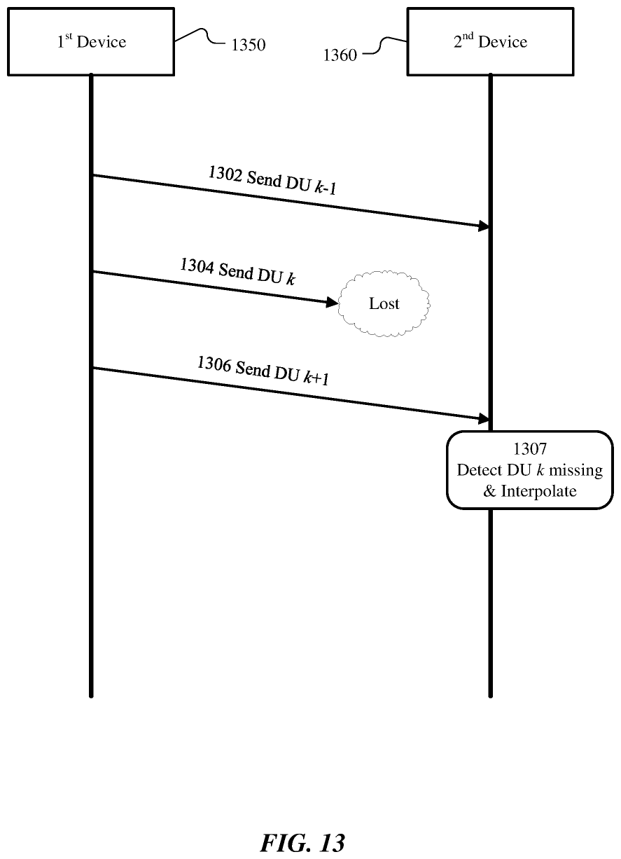

In particular embodiments, the communication device 1100 may receive one or more audio data units from a second communication device among the one or more other communication devices. Each of the one or more audio data units may comprise a field indicating whether the second communication device is in the silence mode when the audio data unit is sent. The field may be in an RTP extension header. The communication device 1100 may detect that k^{th} audio data unit from the second communication device is lost. The communication device 1100 may determine that the second communication device was in the silence mode when the k^{th} audio data unit was sent based on the received k−1^{st} audio data unit and the k+1^{st} audio data unit. The communication device 1100 may perform an interpolation-based packet concealment procedure based on the determination. The communication device 1100 may not send a request for a retransmission of the k^{th} audio data unit to the second communication device. FIG. 13 illustrates an example adaptive retransmission based on information on the messages. As an example and not by way of limitation, illustrated in FIG. 13, the first communication device 1350 and the second communication device 1360 may be in a real-time multimedia communication session. The real-time multimedia communication session may comprise an audio communication and a video communication. At step 1302, the first communication device 1350 may send a k−1^{st} data unit for audio data to the second communication device 1360. The k−1^{st} data unit may be an RTP data unit. The k−1^{st} data unit may comprise a field indicating whether the first communication device 1350 is in the silence mode when the data unit is sent. In particular embodiments, the field may be in an RTP extension header. At step 1304, the first communication device 1350 may send a k^{th} data unit for audio data to the second communication device 1360. The k^{th} data unit for audio data may be lost. The second communication device 1360 may fail to receive the k^{th} data unit for audio data. At step 1306, the first communication device 1350 may send a k+1^{st} data unit for audio data to the second communication device 1360. At step 1307, the second communication device 1360 may detect that the k^{th} data unit for audio data is missing. The second communication device 1360 may determine that the k^{th} data unit for audio data was sent when the first communication device 1350 was in the silence mode based on the additional field in the k−1^{st} data unit and the additional field in the k+1^{st} data unit. The second communication device 1360 may perform a normal interpolation-based packet concealment procedure. The second communication device 1360 may not send a retransmission request for the k^{th} data unit for audio data. Although this disclosure describes determining a retransmission for a data unit generated while a communication device is in the silence mode based on received data in a particular manner, this disclosure contemplates determining a retransmission for a data unit generated while a communication device is in the silence mode based on received data in any suitable manner.

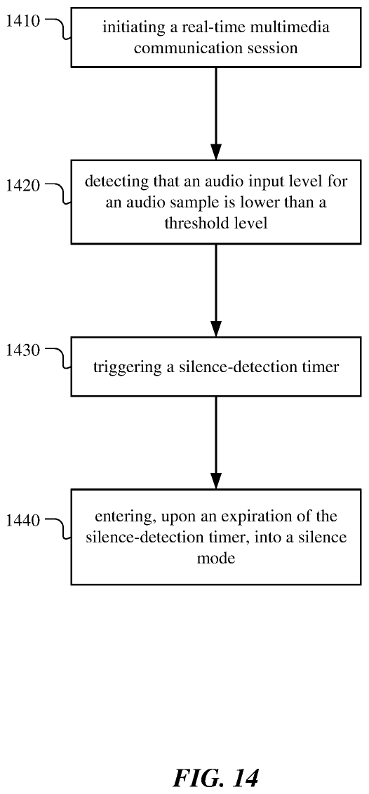

FIG. 14 illustrates an example method 1400 for adjusting audio bandwidth based on audio input levels of audio samples from a microphone. The method may begin at step 1410, where a communication device may initiate a real-time multimedia communication session with one or more other communication devices. At step 1420, the communication device may detect that an audio input level for an audio sample is lower than a threshold level based on sensor data from an audio sensor associated with the communication device. The audio input level being lower than the threshold level may indicate that the user is silent. At step 1430, the communication device may trigger a silence-detection timer. The silence-detection timer may be cancelled when the audio input level for any of following audio samples is higher than the threshold level. At step 1440, the communication device may enter, upon an expiration of the silence-detection timer, into a silence mode. A bandwidth allocated for audio data may be reduced when the communication device is in the silence mode. The communication device may leave the silence mode when the audio input levels for n consecutive audio samples are higher than the threshold level. Particular embodiments may repeat one or more steps of the method of FIG. 14, where appropriate. Although this disclosure describes and illustrates particular steps of the method of FIG. 14 as occurring in a particular order, this disclosure contemplates any suitable steps of the method of FIG. 14 occurring in any suitable order. Moreover, although this disclosure describes and illustrates an example method for adjusting audio bandwidth based on audio input levels of audio samples from a microphone including the particular steps of the method of FIG. 14, this disclosure contemplates any suitable method for adjusting audio bandwidth based on audio input levels of audio samples from a microphone including any suitable steps, which may include all, some, or none of the steps of the method of FIG. 14, where appropriate. Furthermore, although this disclosure describes and illustrates particular components, devices, or systems carrying out particular steps of the method of FIG. 14, this disclosure contemplates any suitable combination of any suitable components, devices, or systems carrying out any suitable steps of the method of FIG. 14.

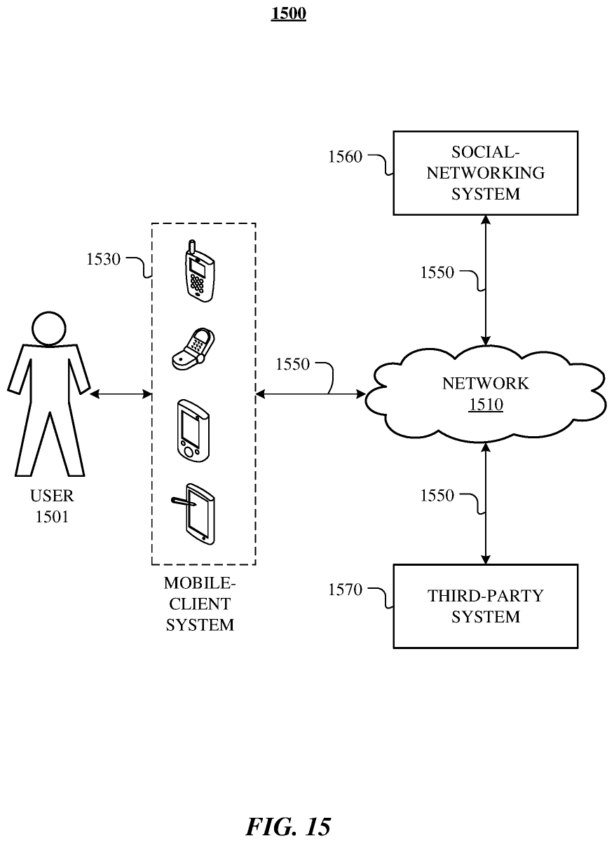

FIG. 15 illustrates an example network environment 1500 associated with a social-networking system. Network environment 1500 includes a user 1501, a client system 1530, a social-networking system 1560, and a third-party system 1570 connected to each other by a network 1510. Although FIG. 15 illustrates a particular arrangement of user 1501, client system 1530, social-networking system 1560, third-party system 1570, and network 1510, this disclosure contemplates any suitable arrangement of user 1501, client system 1530, social-networking system 1560, third-party system 1570, and network 1510. As an example and not by way of limitation, two or more of client system 1530, social-networking system 1560, and third-party system 1570 may be connected to each other directly, bypassing network 1510. As another example, two or more of client system 1530, social-networking system 1560, and third-party system 1570 may be physically or logically co-located with each other in whole or in part. Moreover, although FIG. 15 illustrates a particular number of users 1501, client systems 1530, social-networking systems 1560, third-party systems 1570, and networks 1510, this disclosure contemplates any suitable number of users 1501, client systems 1530, social-networking systems 1560, third-party systems 1570, and networks 1510. As an example and not by way of limitation, network environment 1500 may include multiple users 1501, client system 1530, social-networking systems 1560, third-party systems 1570, and networks 1510.

In particular embodiments, user 1501 may be an individual (human user), an entity (e.g., an enterprise, business, or third-party application), or a group (e.g., of individuals or entities) that interacts or communicates with or over social-networking system 1560. In particular embodiments, social-networking system 1560 may be a network-addressable computing system hosting an online social network. Social-networking system 1560 may generate, store, receive, and send social-networking data, such as, for example, user-profile data, concept-profile data, social-graph information, or other suitable data related to the online social network. Social-networking system 1560 may be accessed by the other components of network environment 1500 either directly or via network 1510. In particular embodiments, social-networking system 1560 may include an authorization server (or other suitable component(s)) that allows users 1501 to opt in to or opt out of having their actions logged by social-networking system 1560 or shared with other systems (e.g., third-party systems 1570), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 30 through blocking, data hashing, anonymization, or other suitable techniques as appropriate. In particular embodiments, third-party system 1570 may be a network-addressable computing system that can host real-time communications between client systems 1530. Third-party system 1570 may help a client system 1530 to address one or more other client systems 1530. Also, third-party system 1570 may relay multimedia data packets between the client systems 1530 that are communicating with each other. Third-party system 1570 may be accessed by the other components of network environment 1500 either directly or via network 1510. In particular embodiments, one or more users 1501 may use one or more client systems 1530 to access, send data to, and receive data from social-networking system 1560 or third-party system 1570. Client system 1530 may access social-networking system 1560 or third-party system 1570 directly, via network 1510, or via a third-party system. As an example and not by way of limitation, client system 1530 may access third-party system 1570 via social-networking system 1560. Client system 1530 may be any suitable computing device, such as, for example, a personal computer, a laptop computer, a cellular telephone, a smartphone, a tablet computer, or an augmented/virtual reality device.

This disclosure contemplates any suitable network 1510. As an example and not by way of limitation, one or more portions of network 1510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1510 may include one or more networks 1510.

Links 1550 may connect client system 1530, social-networking system 1560, and third-party system 1570 to communication network 1510 or to each other. This disclosure contemplates any suitable links 1550. In particular embodiments, one or more links 1550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 1550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 1550, or a combination of two or more such links 1550. Links 1550 need not necessarily be the same throughout network environment 1500. One or more first links 1550 may differ in one or more respects from one or more second links 1550.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

### DESCRIPTION OF EXAMPLE EMBODIMENTS (MESSAGE SEARCHING AND MINING)

The present embodiments are directed toward user context based message searches, in accordance with the presently disclosed embodiments. In certain embodiments, a service platform may cause an electronic device to display one or more applications to a user, in which the one or more applications is associated with one or more messages of a number of messages. In certain embodiments, the service platform may then determine a context in which the user is interacting with the one or more applications. In certain embodiments, the service platform may then determine, based on the context, that the user intends to retrieve at least one message of the number of messages while the user is interacting with the one or more applications. In certain embodiments, the service platform may then generate a confidence score for each of the plurality of messages based on the user intent to retrieve the at least one message. In certain embodiments, the confidence score may indicate a likelihood that the user is interacting with one or more applications include the at least one message.

For example, in certain embodiments, the service platform may monitor user context (e.g., the applications currently being used by the user and/or running in the background; the displayed content the user of which the user is currently viewing, such as a webpage; the activity in which the user is currently engaged, such as a game; whether the user is browsing content, interacting with the content, or simply reading content; whether the user is listening to audible content; whether the user is speaking; historical user interactions the user may have performed while previously exchanging one or more messages; and so forth) while the user is interacting with one or more displayed or otherwise presented applications. In certain embodiments, the service platform may monitor user context and user interactions across any number of an ecosystem of user electronic devices that may be associated with the user and an account of the user serviced by the service platform. In certain embodiments, in addition to monitoring user content and user interactions with one or more displayed or otherwise presented applications, the service platform may also monitor social features (e.g., how is the user related to the various other users may be interacting while utilizing a messaging application), user physical location (e.g., whether the user is at home or at work; whether the user is currently traveling; whether the user is inside of restaurant or brick-and-mortar store; whether the user is currently exchanging communication with other users via text messaging application, audible messaging application, mobile phone call, videoconference; and so forth).

In certain embodiments, based on the determined user context, the service platform may then generate one or more confidence scores for a number of possible messages or conservations to which the user context mostly likely corresponds. For example, in certain embodiments, based on the determined user context, the service platform may score messages and/or conversations associated with the user and that the user may be attempting to retrieve. In one embodiment, the service platform may generate the one or more confidence scores for a number of possible messages or conservations utilizing one or more machine-learning models, in which the confidence scores may, in one embodiment, correspond to a likelihood score that a current conversation or application includes the message the user is attempting to retrieve and/or a likelihood that the user is looking for a particular message. In certain embodiments, the service platform may train the one or more machine-learning models based on, for example, features such as the social relationship between users or a content summary, or detecting how long or the user may have been attempting to retrieve one or more messages and which of the one or more messages the user actually retrieved. In certain embodiments, once a message or other content data is retrieved, the service platform may cause the electronic device associated with the user to display the retrieved message or other content data.

As used herein, a “destination” may refer to any user defined or developer defined location, environment, entity, object, position, user action, domain, vector space, dimension, geometry, coordinates, array, animation, applet, image, text, blob, file, page, widget, occurrence, event, instance, state, or other abstraction that may be defined within an application to represent a reference position, touch position, or clickthrough position or a join-up point by which users of the application may interact.

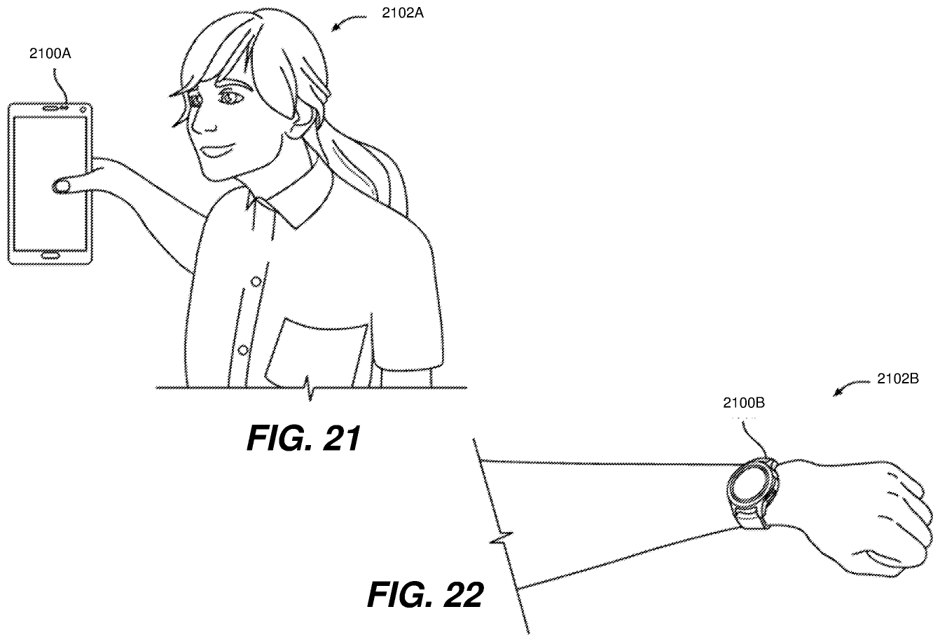

FIG. 21 and FIG. 22 illustrate user devices 2100A, 2100B. For example, in certain embodiments, the user 2102A, 2102B may be associated with a personal electronic device 2100A and a personal electronic device 2100B, respectively. In one embodiment, the personal electronic device 2100A may include, for example, a mobile electronic device (e.g., a mobile phone, a tablet computer, a laptop computer, and so forth) that the user 2102A, 2102B may exchange messages or other communications with one or more other similar users. Similarly, in one embodiment, the personal electronic device 2100B may include, for example, a wearable electronic device (e.g., a watch, an exercise tracker, a medical wristband device, an armband device, and so forth) that the user may wear, for example, around her wrist, around her forearm, or around her neck and may also be utilized by the user 2102A, 2102B to exchange messages or other communications with one or more other similar users.

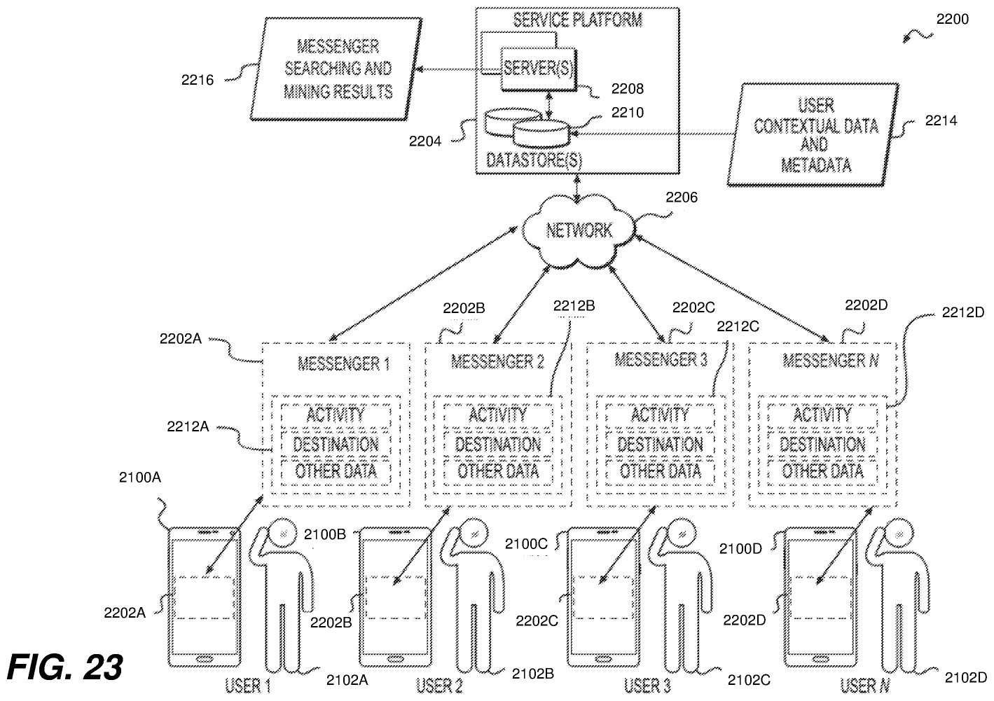

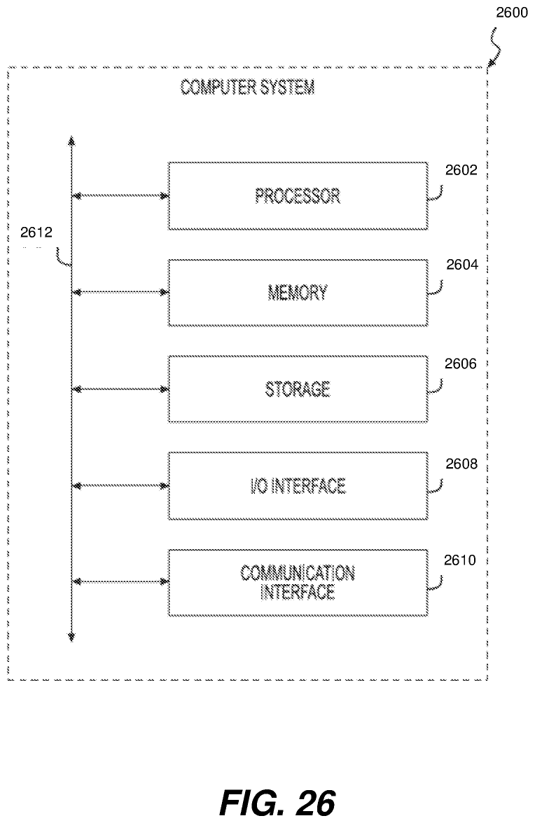

Turning now to FIG. 23, a user device and service platform environment 2200 that may be useful in performing user context based message searching and mining, in accordance with the presently disclosed embodiments. As depicted, the user device and service platform environment 2200 may include a number of users 2102A, 2102B, 2102C, and 2102D each wearing respective user electronic devices 2100A, 2100B, 2100C, and 2100D that may be suitable for allowing the number of users 2102A, 2102B, 2102C, and 2102D to utilize respective messenger or other applications 2202A (e.g., “Messenger Application 1”), 2202B (e.g., “Messenger Application 2”), 2202C (e.g., “Messenger Application 3”), and 2202D (e.g., “Messenger Application N”). Specifically, as depicted by FIG. 26, the respective user electronic devices 2100A, 2100B, 2100C, and 2100D may be coupled to a service platform 2204 via one or more network(s) 2206. In certain embodiments, the service platform 2204 may include, for example, a cloud-based computing architecture suitable for hosting and servicing the messenger or other applications 2202A (e.g., “Messenger Application 1”), 2202B (e.g., “Messenger Application 2”), 2202C (e.g., “Messenger Application 3”), and 2202D (e.g., “Messenger Application N”) executing on the respective user electronic devices 2100A, 2100B, 2100C, and 2100D. For example, in one embodiment, the service platform 2204 may include a Platform as a Service (PaaS) architecture, a Software as a Service (SaaS) architecture, and an Infrastructure as a Service (IaaS), or other similar cloud-based computing architecture.

In certain embodiments, as further depicted by FIG. 23, the service platform 2204 may include one or more processing devices 2208 (e.g., servers) and one or more data stores 2210. For example, in some embodiments, the processing devices 2208 (e.g., servers) may include one or more general purpose processors, or may include one or more graphic processing units (GPUs), one or more application-specific integrated circuits (ASICs), one or more system-on-chips (SoCs), one or more microcontrollers, one or more field-programmable gate arrays (FPGAs), or any other processing device(s) that may be suitable for providing processing and/or computing support for the messenger or other applications 2202A (e.g., “Messenger Application 1”), 2202B (e.g., “Messenger Application 2”), 2202C (e.g., “Messenger Application 3”), and 2202D (e.g., “Messenger Application N”). Similarly, the data stores 2210 may include, for example, one or more internal databases that may be utilized to store information (e.g., user contextual data and metadata 2214) associated with the number of users 2102A, 2102B, 2102C, and 2102D.

In certain embodiments, the service platform 2204 may be a hosting and servicing platform for the messenger or other applications 2202A (e.g., “Messenger Application 1”), 2202B (e.g., “Messenger Application 2”), 2202C (e.g., “Messenger Application 3”), and 2202D (e.g., “Messenger Application N”) executing on the respective user electronic devices 2100A, 2100B, 2100C, and 2100D. For example, in some embodiments, the messenger or other applications 2202A (e.g., “Messenger Application 1”), 2202B (e.g., “Messenger Application 2”), 2202C (e.g., “Messenger Application 3”), and 2202D (e.g., “Messenger Application N”) may each include, for example, applications such as text messaging applications, multimedia messaging applications, video gaming applications (e.g., single-player games, multi-player games), mapping applications, music playback applications, video-sharing platform applications, video-streaming applications, e-commerce applications, social media applications, user interface (UI) applications, or other applications the number of users 2102A, 2102B, 2102C, and 2102D may interact with and navigate therethrough.

In certain embodiments, the service platform 2204 may track, for example, the destinations, the activity statuses, and/or other contextual data and metadata 2212A, 2212B, 2212C, 2212D associated with the respective messenger or other applications 2202A (e.g., “Messenger Application 1”), 2202B (e.g., “Messenger Application 2”), 2202C (e.g., “Messenger Application 3”), and 2202D (e.g., “Messenger Application N”) executing on the user electronic devices 2100A, 2100B, 2100C, and 2100D. For example, in some embodiments, the user destinations within the messenger or other applications 2202A (e.g., “Messenger Application 1”), 2202B (e.g., “Messenger Application 2”), 2202C (e.g., “Messenger Application 3”), and 2202D (e.g., “Messenger Application N”) may include, for example, one or more locations, positions, or objects the users may be interacting with. Similarly, the activity statuses may include, for example, user capacity in a particular one of the messenger or other applications 2202A, 2202B, 2202C, and 2202D or at a particular destination, popularity of a particular one of the messenger or other applications 2202A, 2202B, 2202C, and 2202D or a particular destination (e.g., trending application or destination), a remaining time of a current and active instance within a particular one of the messenger or other applications 2202A, 2202B, 2202C, and 2202D or at particular destination, and so forth.

In certain embodiments, the service platform 2204 may continuously receive and store the destinations, the activity statuses, and/or other contextual data and metadata 2212A, 2212B, 2212C, 2212D associated with the respective messenger or other applications 2202A (e.g., “Messenger Application 1”), 2202B (e.g., “Messenger Application 2”), 2202C (e.g., “Messenger Application 3”), and 2202D (e.g., “Messenger Application N”) executing on the respective user electronic devices 2100A, 2100B, 2100C, and 2100D. For example, in one embodiment, the service platform 2204 may continuously request (e.g., ping) each of the respective messenger or other applications 2202A (e.g., “Messenger Application 1”), 2202B (e.g., “Messenger Application 2”), 2202C (e.g., “Messenger Application 3”), and 2202D (e.g., “Messenger Application N”) for the user contextual data and metadata 2214 (e.g., corresponding to the destinations, the activity statuses, and/or other contextual data and metadata 2212A, 2212B, 2212C, 2212D) at one or more predetermined time intervals (e.g., every 5s, every 10s, every 15s, or every 30s). For example, in some embodiments, the respective messenger or other applications 2202A (e.g., “Messenger Application 1”), 2202B (e.g., “Messenger Application 2”), 2202C (e.g., “Messenger Application 3”), and 2202D (e.g., “Messenger Application N”) executing on the respective user electronic devices 2100A, 2100B, 2100C, and 2100D may each include one or more service layer monitors that may be utilized to monitor and collect the destinations, the activity statuses, and/or other contextual data and metadata 2212A, 2212B, 2212C, 2212D, and continuously provide the destinations, the activity statuses, and/or other contextual data and metadata over a network 2206 to the service platform 2204.

For example, in some embodiments, the respective messenger or other applications 2202A (e.g., “Messenger Application 1”), 2202B (e.g., “Messenger Application 2”), 2202C (e.g., “Messenger Application 3”), and 2202D (e.g., “Messenger Application N”) executing on the respective user electronic devices 2100A, 2100B, 2100C, and 2100D may include one or more service layer monitors that may be utilized to monitor and collect destinations, the activity statuses, and/or other contextual data and metadata 2212A, 2212B, 2212C, 2212D (and provide to the service platform 2204) as the users 2102A (e.g., “User 1), 2102B (e.g., “User 2”), 2102C (e.g., “User 3”), and 2102D (e.g., “User N”) navigate various applications. The one or more service layer monitors on the respective messenger or other applications 2202A (e.g., “Messenger Application 1”), 2202B (e.g., “Messenger Application 2”), 2202C (e.g., “Messenger Application 3”), and 2202D (e.g., “Messenger Application N”) executing on the respective user electronic devices 2100A, 2100B, 2100C, and 2100D may also monitor for metadata such as an identity of the particular user 2102A, 2102B, 2102C, and 2102D associated with the messenger or other applications 2202A (e.g., “Messenger Application 1”), 2202B (e.g., “Messenger Application 2”), 2202C (e.g., “Messenger Application 3”), and 2202D (e.g., “Messenger Application N”), string or identifier associated with, for example, a predetermined user event, user action, or user activity.

In certain embodiments, as further depicted by FIG. 22, the one or more service layer monitors may provide the destinations, the activity statuses, and/or other contextual data and metadata 2212A, 2212B, 2212C, 2212D to the service platform 2204. The service platform 2204 may then aggregate and store the received destinations, the activity statuses, and/or other contextual data and metadata 2212A, 2212B, 2212C, 2212D for each of the respective messenger or other applications 2202A (e.g., “Messenger Application 1”), 2202B (e.g., “Messenger Application 2”), 2202C (e.g., “Messenger Application 3”), and 2202D (e.g., “Messenger Application N”) being currently utilized to, for example, the one or more data stores 2210 (e.g., internal databases). In some embodiments, the service platform 2204 may aggregate and store the received data for each of the respective messenger or other applications 2202A (e.g., “Messenger Application 1”), 2202B (e.g., “Messenger Application 2”), 2202C (e.g., “Messenger Application 3”), and 2202D (e.g., “Messenger Application N”) together with the corresponding one the messenger or other applications 2202A (e.g., “Messenger Application 1”), 2202B (e.g., “Messenger Application 2”), 2202C (e.g., “Messenger Application 3”), and 2202D (e.g., “Messenger Application N”).

In some embodiments, the service platform 2204 may then identify one or more target users of the respective users 2102A (e.g., “User 1”), 2102B (e.g., “User 2”), 2102C (e.g., “User 3”), and 2102D (e.g., “User N”). For example, in some embodiments, the service platform 2204 may detect that a particular one of the respective users 2102A (e.g., “User 1”), 2102B (e.g., “User 2”), 2102C (e.g., “User 3”), and 2102D (e.g., “User N”) has logged into an associated user account maintained by the service platform 2204 and is currently utilizing a particular one of the messenger or other applications 2202A (e.g., “Messenger Application 1”), 2202B (e.g., “Messenger Application 2”), 2202C (e.g., “Messenger Application 3”), and 2202D (e.g., “Messenger Application N”).

In certain embodiments, the service platform 2204 may then select a portion of the received user contextual data and metadata 2214 based on information associated with the particular one of the respective users 2102A (e.g., “User 1”), 2102B (e.g., “User 2”), 2102C (e.g., “User 3”), and 2102D (e.g., “User N”). For example, in some embodiments, the service platform 2204 may aggregate the received user contextual data and metadata 2214 via the processing devices 2208 (e.g., servers) and apply one or more machine-learning algorithms (e.g., deep learning algorithms) and/or rules-based algorithms to determine one or more associations of the particular one of the respective users 2102A (e.g., “User 1”), 2102B (e.g., “User 2”), 2102C (e.g., “User 3”), and 2102D (e.g., “User N”), such as a user destination or application interests, a particular party or group to which the particular one of the respective users 2102A (e.g., “User 1”), 2102B (e.g., “User 2”), 2102C (e.g., “User 3”), and 2102D (e.g., “User N”) belongs, an account profile of the particular one of the respective users 2102A (e.g., “User 1”), 2102B (e.g., “User 2”), 2102C (e.g., “User 3”), and 2102D (e.g., “User N”), a privacy profile of the particular one of the respective users 2102A (e.g., “User 1”), 2102B (e.g., “User 2”), 2102C (e.g., “User 3”), and 2102D (e.g., “User N”), and/or other contextually rich data that may be associated with the particular one of the respective users 2102A (e.g., “User 1”), 2102B (e.g., “User 2”), 2102C (e.g., “User 3”), and 2102D (e.g., “User N”).

In certain embodiments, the service platform 2204 may monitor user 2102A (e.g., “User 1”) context (e.g., the applications currently being used by the user 2102A (e.g., “User 1”) and/or running in the background; the displayed content the user 2102A (e.g., “User 1”) of which the user is currently viewing, such as a webpage; the activity in which the user 2102A (e.g., “User 1”) is currently engaged, such as a game; whether the user 2102A (e.g., “User 1”) is browsing content, interacting with the content, or simply reading content; whether the user 2102A (e.g., “User 1”) is listening to audible content; whether the user 2102A (e.g., “User 1”) is speaking; historical user 2102A (e.g., “User 1”) interactions the user 2102A (e.g., “User 1”) may have performed while previously exchanging one or more messages with other users 2102B (e.g., “User 2”), 2102C (e.g., “User 3”), and 2102D (e.g., “User N”); and so forth) while the user 2102A (e.g., “User 1”) is interacting with one or more displayed or otherwise presented messenger or other applications 2202A (e.g., “Messenger Application 1”). In certain embodiments, the service platform 2204 may monitor user 2102A (e.g., “User 1”) context and user 2102A (e.g., “User 1”) interactions across any number of an ecosystem of user electronic devices that may be associated with the user 2102A (e.g., “User 1”) and an account of the user serviced by the service platform 2204. In certain embodiments, in addition to monitoring user 2102A (e.g., “User 1”) content and user 2102A (e.g., “User 1”) interactions with one or more displayed or otherwise presented applications, the service platform 2204 may also monitor social features (e.g., how is the user 2102A (e.g., “User 1”) related to the various other users 2102B (e.g., “User 2”), 2102C (e.g., “User 3”), and 2102D (e.g., “User N”) may be interacting while utilizing a messaging application), user physical location (e.g., whether the user 2102A (e.g., “User 1”) is at home or at work; whether the user 2102A (e.g., “User 1”) is currently traveling; whether the user 2102A (e.g., “User 1”) is inside of restaurant or brick-and-mortar store; whether the user 2102A (e.g., “User 1”) is currently exchanging communication with other users 2102B (e.g., “User 2”), 2102C (e.g., “User 3”), and 2102D (e.g., “User N”) via text messaging application, audible messaging application, mobile phone call, videoconference; and so forth).

In certain embodiments, based on the determined user context, the service platform 2204 may then generate one or more confidence scores for a number of possible messages or conservations to which the user 2102A (e.g., “User 1”) context mostly likely corresponds. For example, in certain embodiments, based on the determined user context, the service platform 2204 may score messages and/or conversations associated with the user 2102A (e.g., “User 1”) and that the user 2102A (e.g., “User 1”) may be attempting to retrieve. In one embodiment, the service platform 2204 may generate the one or more confidence scores for a number of possible messages or conservations utilizing one or more machine-learning models, in which the confidence scores may, in one embodiment, correspond to a likelihood score that a current conversation or application includes the message the user is attempting to retrieve and/or a likelihood that the user 2102A (e.g., “User 1”) is looking for a particular message. In certain embodiments, the service platform 2204 may train the one or more machine-learning models based on, for example, features such as the social relationship between users or a content summary, or detecting how long or the user 2102A (e.g., “User 1”) may have been attempting to retrieve one or more messages and which of the one or more messages the user actually retrieved.

In certain embodiments, once a message or other content data is retrieved, the service platform 2204 may cause the electronic device associated with the user 2102A (e.g., “User 1”) to display the retrieved message or other content data. For example, in certain embodiments, the service platform 2204 may then generate and transmit message searching and mining results data 2216 for the particular one of the users 2102A (e.g., “User 1”), 2102B (e.g., “User 2”), 2102C (e.g., “User 3”), and 2102D (e.g., “User N”) based on the received user contextual data and metadata 2214. For example, in some embodiments, the service platform 2204 may generate message searching and mining results data 2216 for a particular one of the users 2102A (e.g., “User 1”), 2102B (e.g., “User 2”), 2102C (e.g., “User 3”), and 2102D (e.g., “User N”) to be provided, for example, to the messenger or other applications 2202A (e.g., “Messenger Application 1”), 2202B (e.g., “Messenger Application 2”), 2202C (e.g., “Messenger Application 3”), and 2202D (e.g., “Messenger Application N”) executing on the user electronic devices 2100A, 2100B, 2100C, and 2100D associated with the particular user. In certain embodiments, the service platform 2204 may cause the user electronic device 2100A, for example, to display the message searching and mining results data 2216, for example, as an instance showing highly scored messages (or conversations or other content data) or as bubbles appearing near a scrollbar such that the user 2102A (e.g., “User 1”) may easily select the search in the message searching and mining results data 2216. In certain embodiments, the service platform 2204 may also include a trigger that may trigger the message searching and mining techniques described herein when, for example, a clear search intent expressed by the user 2102A (e.g., “User 1”) is determined (e.g., the user 2102A (e.g., “User 1”) telling another person they are looking for a message), or when, for example, an implicit search intent of the user is determined (e.g., conversation on the application 2202A (e.g., “Messenger Application 1” or when the user launches the application 2202A (e.g., “Messenger Application 1”) and begins scrolling or gazing at one or more particular objects of the application.

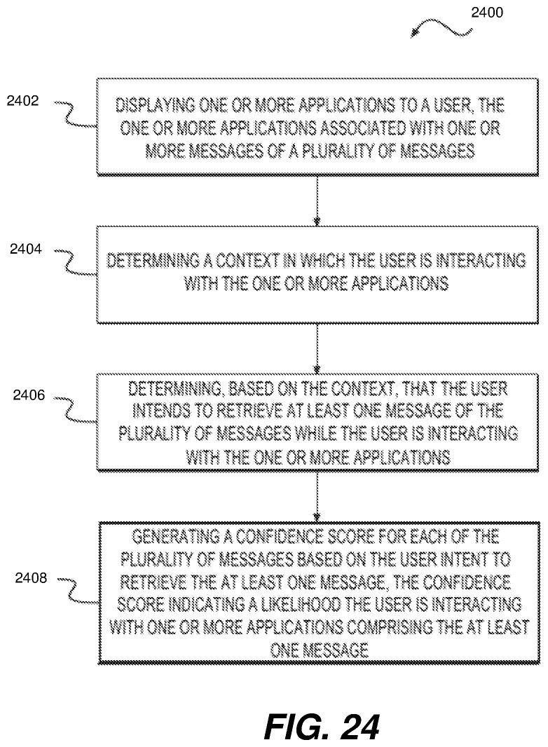

FIG. 24 illustrates a flow diagram of a method 2400 for inclusive rendering of various human facial tones, in accordance with presently disclosed techniques. The method 2400 may be performed utilizing one or more processing devices (e.g., computing platform 2204) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 2400 may begin at block 2402 with one or more processing devices (e.g., service platform 2204) displaying one or more applications to a user, wherein the one or more applications is associated with one or more messages of a plurality of messages. The method 2400 may then continue at block 2404 with the one or more processing devices (e.g., service platform 2204) determining a context in which the user is interacting with the one or more applications. The method 2400 may then continue at block 2406 with the one or more processing devices (e.g., service platform 2204) determining, based on the context, that the user intends to retrieve at least one message of the plurality of messages while the user is interacting with the one or more applications. The method 2400 may then conclude at block 2408 with the one or more processing devices (e.g., service platform 2204) generating a confidence score for each of the plurality of messages based on the user intent to retrieve the at least one message, the confidence score indicating a likelihood that the user is interacting with one or more applications comprising the at least one message.

Accordingly, as described by the method 2400 of FIG. 24, the present techniques are directed toward user context based message searching and mining, in accordance with the presently disclosed embodiments. In certain embodiments, a service platform may cause an electronic device to display one or more applications to a user, in which the one or more applications is associated with one or more messages of a number of messages. In certain embodiments, the service platform may then determine a context in which the user is interacting with the one or more applications. In certain embodiments, the service platform may then determine, based on the context, that the user intends to retrieve at least one message of the number of messages while the user is interacting with the one or more applications. In certain embodiments, the service platform may then generate a confidence score for each of the plurality of messages based on the user intent to retrieve the at least one message. In certain embodiments, the confidence score may indicate a likelihood that the user is interacting with one or more applications include the at least one message.

For example, in certain embodiments, the service platform may monitor user context (e.g., the applications currently being used by the user and/or running in the background; the displayed content the user of which the user is currently viewing, such as a webpage; the activity in which the user is currently engaged, such as a game; whether the user is browsing content, interacting with the content, or simply reading content; whether the user is listening to audible content; whether the user is speaking; historical user interactions the user may have performed while previously exchanging one or more messages; and so forth) while the user is interacting with one or more displayed or otherwise presented applications. In certain embodiments, the service platform may monitor user context and user interactions across any number of an ecosystem of user electronic devices that may be associated with the user and an account of the user serviced by the service platform. In certain embodiments, in addition to monitoring user content and user interactions with one or more displayed or otherwise presented applications, the service platform may also monitor social features (e.g., how is the user related to the various other users may be interacting while utilizing a messaging application), user physical location (e.g., whether the user is at home or at work; whether the user is currently traveling; whether the user is inside of restaurant or brick-and-mortar store; whether the user is currently exchanging communication with other users via text messaging application, audible messaging application, mobile phone call, videoconference; and so forth).

In certain embodiments, based on the determined user context, the service platform may then generate one or more confidence scores for a number of possible messages or conservations to which the user context mostly likely corresponds. For example, in certain embodiments, based on the determined user context, the service platform may score messages and/or conversations associated with the user and that the user may be attempting to retrieve. In one embodiment, the service platform may generate the one or more confidence scores for a number of possible messages or conservations utilizing one or more machine-learning models, in which the confidence scores may, in one embodiment, correspond to a likelihood score that a current conversation or application includes the message the user is attempting to retrieve and/or a likelihood that the user is looking for a particular message. In certain embodiments, the service platform may train the one or more machine-learning models based on, for example, features such as the social relationship between users or a content summary, or detecting how long or the user may have been attempting to retrieve one or more messages and which of the one or more messages the user actually retrieved. In certain embodiments, once a message or other content data is retrieved, the service platform may cause the electronic device associated with the user to display the retrieved message or other content data.

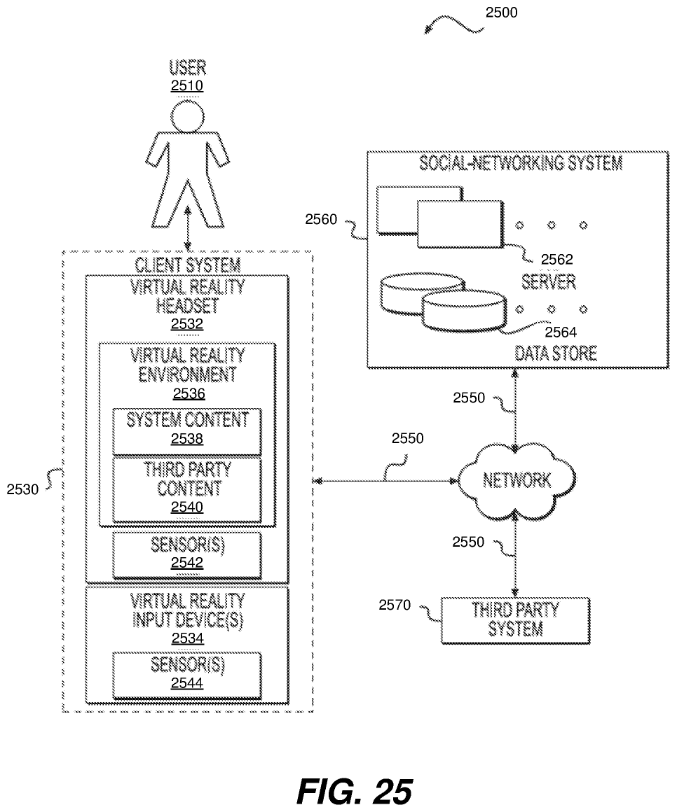

FIG. 25 illustrates an example network environment 2500 associated with a virtual reality system. Network environment 2500 includes a user 2501 interacting with a client system 2530, a social-networking system 2560, and a third-party system 2570 connected to each other by a network 2510. Although FIG. 25 illustrates a particular arrangement of a user 2501, a client system 2530, a social-networking system 2560, a third-party system 2570, and a network 2510, this disclosure contemplates any suitable arrangement of a user 2501, a client system 2530, a social-networking system 2560, a third-party system 2570, and a network 2510. As an example, and not by way of limitation, two or more of users 2501, a client system 2530, a social-networking system 2560, and a third-party system 2570 may be connected to each other directly, bypassing a network 2510. As another example, two or more of client systems 2530, a social-networking system 2560, and a third-party system 2570 may be physically or logically co-located with each other in whole or in part. Moreover, although FIG. 25 illustrates a particular number of users 2501, client systems 2530, social-networking systems 2560, third-party systems 2570, and networks 2510, this disclosure contemplates any suitable number of client systems 2530, social-networking systems 2560, third-party systems 2570, and networks 2510. As an example, and not by way of limitation, network environment 2500 may include multiple users 2501, client systems 2530, social-networking systems 2560, third-party systems 2570, and networks 2510.

This disclosure contemplates any suitable network 2510. As an example, and not by way of limitation, one or more portions of a network 2510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 2510 may include one or more networks 2510. Links 2550 may connect a client system 2530, a social-networking system 2560, and a third-party system 2570 to a communication network 2510 or to each other. This disclosure contemplates any suitable links 2550. In certain embodiments, one or more links 2550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In certain embodiments, one or more links 2550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 2550, or a combination of two or more such links 2550. Links 2550 need not necessarily be the same throughout a network environment 2500. One or more first links 2550 may differ in one or more respects from one or more second links 2550.

In certain embodiments, a client system 2530 may be an electronic device including hardware, software, or embedded logic components or a combination of two or more such components and capable of carrying out the appropriate functionalities implemented or supported by a client system 2530. As an example, and not by way of limitation, a client system 2530 may include a computer system such as a desktop computer, notebook or laptop computer, netbook, a tablet computer, e-book reader, GPS device, camera, personal digital assistant (PDA), handheld electronic device, cellular telephone, smartphone, virtual reality headset and controllers, other suitable electronic device, or any suitable combination thereof. This disclosure contemplates any suitable client systems 2530. A client system 2530 may enable a network user at a client system 2530 to access a network 2510. A client system 2530 may enable its user to communicate with other users at other client systems 2530. A client system 2530 may generate a virtual reality environment for a user to interact with content.

In certain embodiments, a client system 2530 may include a virtual reality (or augmented reality) headset 2532, such as OCULUS RIFT and the like, and virtual reality input device(s) 2534, such as a virtual reality controller. A user at a client system 2530 may wear the virtual reality headset 2532 and use the virtual reality input device(s) to interact with a virtual reality environment 2536 generated by the virtual reality headset 2532. Although not shown, a client system 2530 may also include a separate processing computer and/or any other component of a virtual reality system. A virtual reality headset 2532 may generate a virtual reality environment 2536, which may include system content 2538 (including but not limited to the operating system), such as software or firmware updates and also include third-party content 2540, such as content from applications or dynamically downloaded from the Internet (e.g., web page content). A virtual reality headset 2532 may include sensor(s) 2542, such as accelerometers, gyroscopes, magnetometers to generate sensor data that tracks the location of the headset 2532. The headset 2532 may also include eye trackers for tracking the position of the user's eyes or their viewing directions. The client system may use data from the sensor(s) 2542 to determine velocity, orientation, and gravitation forces with respect to the headset.

Virtual reality input device(s) 2534 may include sensor(s) 2544, such as accelerometers, gyroscopes, magnetometers, and touch sensors to generate sensor data that tracks the location of the input device 2534 and the positions of the user's fingers. The client system 2530 may make use of outside-in tracking, in which a tracking camera (not shown) is placed external to the virtual reality headset 2532 and within the line of sight of the virtual reality headset 2532. In outside-in tracking, the tracking camera may track the location of the virtual reality headset 2532 (e.g., by tracking one or more infrared LED markers on the virtual reality headset 2532). Alternatively, or additionally, the client system 2530 may make use of inside-out tracking, in which a tracking camera (not shown) may be placed on or within the virtual reality headset 2532 itself. In inside-out tracking, the tracking camera may capture images around it in the real world and may use the changing perspectives of the real world to determine its own position in space.

Third-party content 2540 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 2530 may enter a Uniform Resource Locator (URL) or other address directing a web browser to a particular server (such as server 2562, or a server associated with a third-party system 2570), and the web browser may generate a Hyper Text Transfer Protocol (HTTP) request and communicate the HTTP request to server. The server may accept the HTTP request and communicate to a client system 2530 one or more Hyper Text Markup Language (HTML) files responsive to the HTTP request. The client system 2530 may render a web interface (e.g. a webpage) based on the HTML files from the server for presentation to the user. This disclosure contemplates any suitable source files. As an example, and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In certain embodiments, the social-networking system 2560 may be a network-addressable computing system that can host an online social network. The social-networking system 2560 may generate, store, receive, and send social-networking data, such as, for example, user-profile data, concept-profile data, social-graph information, or other suitable data related to the online social network. The social-networking system 2560 may be accessed by the other components of network environment 2500 either directly or via a network 2510. As an example, and not by way of limitation, a client system 2530 may access the social-networking system 2560 using a web browser of a third-party content 2540, or a native application associated with the social-networking system 2560 (e.g., a mobile social-networking application, a messaging application, another suitable application, or any combination thereof) either directly or via a network 2510. In certain embodiments, the social-networking system 2560 may include one or more servers 2562. Each server 2562 may be a unitary server or a distributed server spanning multiple computers or multiple datacenters. Servers 2562 may be of various types, such as, for example and without limitation, web server, news server, mail server, message server, advertising server, file server, application server, exchange server, database server, proxy server, another server suitable for performing functions or processes described herein, or any combination thereof.

In certain embodiments, each server 2562 may include hardware, software, or embedded logic components or a combination of two or more such components for carrying out the appropriate functionalities implemented or supported by server 2562. In certain embodiments, the social-networking system 2560 may include one or more data stores 2564. Data stores 2564 may be used to store various types of information. In certain embodiments, the information stored in data stores 2564 may be organized according to specific data structures. In certain embodiments, each data store 2564 may be a relational, columnar, correlation, or other suitable database. Although this disclosure describes or illustrates particular types of databases, this disclosure contemplates any suitable types of databases. Certain embodiments may provide interfaces that enable a client system 2530, a social-networking system 2560, or a third-party system 2570 to manage, retrieve, modify, add, or delete, the information stored in data store 2564.

In certain embodiments, the social-networking system 2560 may store one or more social graphs in one or more data stores 2564. In certain embodiments, a social graph may include multiple nodes—which may include multiple user nodes (each corresponding to a particular user) or multiple concept nodes (each corresponding to a particular concept)—and multiple edges connecting the nodes. The social-networking system 2560 may provide users of the online social network the ability to communicate and interact with other users. In certain embodiments, users may join the online social network via the social-networking system 2560 and then add connections (e.g., relationships) to a number of other users of the social-networking system 2560 whom they want to be connected to. Herein, the term “friend” may refer to any other user of the social-networking system 2560 with whom a user has formed a connection, association, or relationship via the social-networking system 2560.

In certain embodiments, the social-networking system 2560 may provide users with the ability to take actions on various types of items or objects, supported by the social-networking system 2560. As an example, and not by way of limitation, the items and objects may include groups or social networks to which users of the social-networking system 2560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 2560 or by an external system of a third-party system 2570, which is separate from the social-networking system 2560 and coupled to the social-networking system 2560 via a network 2510.

In certain embodiments, the social-networking system 2560 may be capable of linking a variety of entities. As an example, and not by way of limitation, the social-networking system 2560 may enable users to interact with each other as well as receive content from third-party systems 2570 or other entities, or to allow users to interact with these entities through an application programming interfaces (API) or other communication channels. In certain embodiments, a third-party system 2570 may include one or more types of servers, one or more data stores, one or more interfaces, including but not limited to APIs, one or more web services, one or more content sources, one or more networks, or any other suitable components, e.g., that servers may communicate with. A third-party system 2570 may be operated by a different entity from an entity operating the social-networking system 2560. In certain embodiments, however, the social-networking system 2560 and third-party systems 2570 may operate in conjunction with each other to provide social-networking services to users of the social-networking system 2560 or third-party systems 2570. In this sense, the social-networking system 2560 may provide a platform, or backbone, which other systems, such as third-party systems 2570, may use to provide social-networking services and functionality to users across the Internet.

In certain embodiments, a third-party system 2570 may include a third-party content object provider. A third-party content object provider may include one or more sources of content objects, which may be communicated to a client system 2530. As an example, and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In certain embodiments, the social-networking system 2560 also includes user-generated content objects, which may enhance a user's interactions with the social-networking system 2560. User-generated content may include anything a user can add, upload, send, or “post” to the social-networking system 2560. As an example, and not by way of limitation, a user communicates posts to the social-networking system 2560 from a client system 2530. Posts may include data such as status updates or other textual data, location information, photos, videos, links, music or other similar data or media. Content may also be added to the social-networking system 2560 by a third-party through a “communication channel,” such as a newsfeed or stream. In certain embodiments, the social-networking system 2560 may include a variety of servers, sub-systems, programs, modules, logs, and data stores. In certain embodiments, the social-networking system 2560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 2560 may also include suitable components such as network interfaces, security mechanisms, load balancers, failover servers, management-and-network-operations consoles, other suitable components, or any suitable combination thereof.

In certain embodiments, the social-networking system 2560 may include one or more user-profile stores for storing user profiles. A user profile may include, for example, biographic information, demographic information, behavioral information, social information, or other types of descriptive information, such as work interact with, educational history, hobbies or preferences, interests, affinities, or location. Interest information may include interests related to one or more categories. Categories may be general or specific. As an example, and not by way of limitation, if a user “likes” an article about a brand of shoes the category may be the brand, or the general category of “shoes” or “clothing.” A connection store may be used for storing connection information about users. The connection information may indicate users who have similar or common work interact with, group memberships, hobbies, educational history, or are in any way related or share common attributes. The connection information may also include user-defined connections between different users and content (both internal and external). A web server may be used for linking the social-networking system 2560 to one or more client systems 2530 or one or more third-party systems 2570 via a network 2510. The web server may include a mail server or other messaging functionality for receiving and routing messages between the social-networking system 2560 and one or more client systems 2530. An API-request server may allow a third-party system 2570 to access information from the social-networking system 2560 by calling one or more APIs. An action logger may be used to receive communications from a web server about a user's actions on or off the social-networking system 2560.

In conjunction with the action log, a third-party-content-object log may be maintained of user exposures to third-party-content objects. A notification controller may provide information regarding content objects to a client system 2530. Information may be pushed to a client system 2530 as notifications, or information may be pulled from a client system 2530 responsive to a request received from a client system 2530. Authorization servers may be used to enforce one or more privacy settings of the users of the social-networking system 2560. A privacy setting of a user determines how particular information associated with a user can be shared. The authorization server may allow users to opt in to or opt out of having their actions logged by the social-networking system 2560 or shared with other systems (e.g., a third-party system 2570), such as, for example, by setting appropriate privacy settings. Third-party-content-object stores may be used to store content objects received from third parties, such as a third-party system 2570. Location stores may be used for storing location information received from client systems 2530 associated with users. Advertisement-pricing modules may combine social information, the current time, location information, or other suitable information to provide relevant advertisements, in the form of notifications, to a user.

FIG. 26 illustrates an example computer system 2600 that may be useful in performing one or more of the foregoing techniques as presently disclosed herein. In certain embodiments, one or more computer systems 2600 perform one or more steps of one or more methods described or illustrated herein. In certain embodiments, one or more computer systems 2600 provide functionality described or illustrated herein. In certain embodiments, software running on one or more computer systems 2600 performs one or more steps of one or more methods described or illustrated herein or provides functionality described or illustrated herein. Certain embodiments include one or more portions of one or more computer systems 2600. Herein, reference to a computer system may encompass a computing device, and vice versa, where appropriate. Moreover, reference to a computer system may encompass one or more computer systems, where appropriate.

This disclosure contemplates any suitable number of computer systems 2600. This disclosure contemplates computer system 2600 taking any suitable physical form. As example and not by way of limitation, computer system 2600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 2600 may include one or more computer systems 2600; be unitary or distributed; span multiple locations; span multiple machines; span multiple data centers; or reside in a cloud, which may include one or more cloud components in one or more networks. Where appropriate, one or more computer systems 2600 may perform without substantial spatial or temporal limitation one or more steps of one or more methods described or illustrated herein.

As an example, and not by way of limitation, one or more computer systems 2600 may perform in real time or in batch mode one or more steps of one or more methods described or illustrated herein. One or more computer systems 2600 may perform at different times or at different locations one or more steps of one or more methods described or illustrated herein, where appropriate. In certain embodiments, computer system 2600 includes a processor 2602, memory 2604, storage 2606, an input/output (I/O) interface 2608, a communication interface 2610, and a bus 2612. Although this disclosure describes and illustrates a particular computer system having a particular number of particular components in a particular arrangement, this disclosure contemplates any suitable computer system having any suitable number of any suitable components in any suitable arrangement.

In certain embodiments, processor 2602 includes hardware for executing instructions, such as those making up a computer program. As an example, and not by way of limitation, to execute instructions, processor 2602 may retrieve (or fetch) the instructions from an internal register, an internal cache, memory 2604, or storage 2606; decode and execute them; and then write one or more results to an internal register, an internal cache, memory 2604, or storage 2606. In certain embodiments, processor 2602 may include one or more internal caches for data, instructions, or addresses. This disclosure contemplates processor 2602 including any suitable number of any suitable internal caches, where appropriate. As an example, and not by way of limitation, processor 2602 may include one or more instruction caches, one or more data caches, and one or more translation lookaside buffers (TLBs). Instructions in the instruction caches may be copies of instructions in memory 2604 or storage 2606, and the instruction caches may speed up retrieval of those instructions by processor 2602.

Data in the data caches may be copies of data in memory 2604 or storage 2606 for instructions executing at processor 2602 to operate on; the results of previous instructions executed at processor 2602 for access by subsequent instructions executing at processor 2602 or for writing to memory 2604 or storage 2606; or other suitable data. The data caches may speed up read or write operations by processor 2602. The TLBs may speed up virtual-address translation for processor 2602. In certain embodiments, processor 2602 may include one or more internal registers for data, instructions, or addresses. This disclosure contemplates processor 2602 including any suitable number of any suitable internal registers, where appropriate. Where appropriate, processor 2602 may include one or more arithmetic logic units (ALUs); be a multi-core processor; or include one or more processors 2602. Although this disclosure describes and illustrates a particular processor, this disclosure contemplates any suitable processor.

In certain embodiments, memory 2604 includes main memory for storing instructions for processor 2602 to execute or data for processor 2602 to operate on. As an example, and not by way of limitation, computer system 2600 may load instructions from storage 2606 or another source (such as, for example, another computer system 2600) to memory 2604. Processor 2602 may then load the instructions from memory 2604 to an internal register or internal cache. To execute the instructions, processor 2602 may retrieve the instructions from the internal register or internal cache and decode them. During or after execution of the instructions, processor 2602 may write one or more results (which may be intermediate or final results) to the internal register or internal cache. Processor 2602 may then write one or more of those results to memory 2604. In certain embodiments, processor 2602 executes only instructions in one or more internal registers or internal caches or in memory 2604 (as opposed to storage 2606 or elsewhere) and operates only on data in one or more internal registers or internal caches or in memory 2604 (as opposed to storage 2606 or elsewhere).

One or more memory buses (which may each include an address bus and a data bus) may couple processor 2602 to memory 2604. Bus 2612 may include one or more memory buses, as described below. In certain embodiments, one or more memory management units (MMUs) reside between processor 2602 and memory 2604 and facilitate accesses to memory 2604 requested by processor 2602. In certain embodiments, memory 2604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2604 may include one or more memories 2604, where appropriate. Although this disclosure describes and illustrates particular memory, this disclosure contemplates any suitable memory.

In certain embodiments, storage 2606 includes mass storage for data or instructions. As an example, and not by way of limitation, storage 2606 may include a hard disk drive (HDD), a floppy disk drive, flash memory, an optical disc, a magneto-optical disc, magnetic tape, or a Universal Serial Bus (USB) drive or a combination of two or more of these. Storage 2606 may include removable or non-removable (or fixed) media, where appropriate. Storage 2606 may be internal or external to computer system 2600, where appropriate. In certain embodiments, storage 2606 is non-volatile, solid-state memory. In certain embodiments, storage 2606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2606 taking any suitable physical form. Storage 2606 may include one or more storage control units facilitating communication between processor 2602 and storage 2606, where appropriate. Where appropriate, storage 2606 may include one or more storages 2606. Although this disclosure describes and illustrates particular storage, this disclosure contemplates any suitable storage.

In certain embodiments, I/O interface 2608 includes hardware, software, or both, providing one or more interfaces for communication between computer system 2600 and one or more I/O devices. Computer system 2600 may include one or more of these I/O devices, where appropriate. One or more of these I/O devices may enable communication between a person and computer system 2600. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2608 for them. Where appropriate, I/O interface 2608 may include one or more device or software drivers enabling processor 2602 to drive one or more of these I/O devices. I/O interface 2608 may include one or more I/O interfaces 2608, where appropriate. Although this disclosure describes and illustrates a particular I/O interface, this disclosure contemplates any suitable I/O interface.

In certain embodiments, communication interface 2610 includes hardware, software, or both providing one or more interfaces for communication (such as, for example, packet-based communication) between computer system 2600 and one or more other computer systems 2600 or one or more networks. As an example, and not by way of limitation, communication interface 2610 may include a network interface controller (NIC) or network adapter for communicating with an Ethernet or other wire-based network or a wireless NIC (WNIC) or wireless adapter for communicating with a wireless network, such as a Wi-Fi network. This disclosure contemplates any suitable network and any suitable communication interface 2610 for it.

As an example, and not by way of limitation, computer system 2600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2600 may include any suitable communication interface 2610 for any of these networks, where appropriate. Communication interface 2610 may include one or more communication interfaces 2610, where appropriate. Although this disclosure describes and illustrates a particular communication interface, this disclosure contemplates any suitable communication interface.

In certain embodiments, bus 2612 includes hardware, software, or both coupling components of computer system 2600 to each other. As an example, and not by way of limitation, bus 2612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2612 may include one or more buses 2612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates certain embodiments as providing particular advantages, certain embodiments may provide none, some, or all of these advantages.

What is claimed is:

1. A method comprising, by a communication device associated with a user:
initiating a real-time multimedia communication session with one or more other communication devices;
detecting, based on sensor data from an audio sensor associated with the communication device, that an audio input level for an audio sample is lower than a threshold level, wherein the audio input level being lower than the threshold level indicates that the user is silent;
triggering a silence-detection timer, wherein the silence-detection timer is cancelled when the audio input level for any of following audio samples is higher than the threshold level; and
entering, upon an expiration of the silence-detection timer, into a silence mode, wherein a bandwidth allocated for audio data is reduced when the communication device is in the silence mode, and wherein the communication device leaves the silence mode when the audio input levels for n consecutive audio samples are higher than the threshold level.

2. The method of claim 1, further comprising:
preparing an audio data unit while the communication device is in the silence mode;
caching the prepared audio data unit, wherein the cached audio data unit has an additional field indicating that the audio data unit does not need to be re-transmitted;
sending the prepared audio data unit to the one or more communication devices;
receiving, from one of the one or more communication devices, a request for a re-transmission of the prepared audio data unit; and
deciding, based on the additional field of the cached audio data unit, to ignore the request.

3. The method of claim 2, wherein the prepared audio data unit is a Real-time Transport Protocol (RTP) data unit.

4. The method of claim 2, wherein the request is an RTP Control Protocol (RTCP)-Negative Acknowledgement (NACK) message.

5. The method of claim 1, further comprising:
receiving one or more audio data units from a second communication device among the one or more other communication devices, wherein each of the one or more audio data units comprises a field indicating whether the second communication device is in the silence mode when the audio data unit is sent;
detecting that k^{th} audio data unit from the second communication device is lost;
determining, based on received k−1^{st} audio data unit and k+1^{st} audio data unit, that the second communication device was in the silence mode when the k^{th} audio data unit was sent; and
performing, based on the determination, an interpolation-based packet concealment.

6. A method comprising, by a computing device:
displaying one or more applications to a user, wherein the one or more applications is associated with one or more messages of a plurality of messages;
determining a context in which the user is interacting with the one or more applications;
determining, based on the context, that the user intends to retrieve at least one message of the plurality of messages while the user is interacting with the one or more applications; and
generating a confidence score for each of the plurality of messages based on the user intent to retrieve the at least one message, the confidence score indicating a likelihood that the user is interacting with one or more applications comprising the at least one message.
